(19) United States
(12) Patent Application Publication
(10) Pub. No.: US 2010/0157480 A1
(43) Pub. Date: Jun. 24, 2010

(54) HEAD SLIDER AND STORAGE DEVICE

(75) Inventor: Hikaru WATANABE, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/640,538

(22) Filed: Dec. 17, 2009

(30) Foreign Application Priority Data
Dec. 18, 2008 (JP) 2008-322334

(51) Int. Cl. G11B 5/60

(52) U.S. Cl. 360/235.4; G9B/5.229

(57) ABSTRACT

According to one embodiment, a head slider includes a center pad, a pair of center rails, and a center rail connection wall. The center pad is located in the center on the air outflow end side. The center rails extend toward the air inflow end side continuously from the center pad. The center rail connection wall connects the ends of the center rails on the air inflow end side to surround a space between the center pad and the center rails, and has a height between the top surface and the bottom surface of a floating surface.

### CROSS-REFERENCE TO RELATED APPLICATIONS

This application is based upon and claims the benefit of priority from Japanese Patent Application No. 2008-322334, filed Dec. 18, 2008, the entire contents of which are incorporated herein by reference.

### BACKGROUND

1. Field

One embodiment of the invention relates to a head slider that writes data to or reads data from a storage medium and a storage device with the head slider.

2. Description of the Related Art

In general, a magnetic disk device that is a storage device using a magnetic disk as a storage medium comprises a rotatable magnetic disk and a magnetic head slider supported and positioned by a head support mechanism, and has a record/reproduction element mounted on the magnetic head slider. The magnetic head slider has an air bearing surface, i.e., a floating surface, and floats on the magnetic disk at a constant gap due to dynamical pressure caused by the rotation of the magnetic disk to read data recorded on the magnetic disk.

Recent magnetic disk devices are required to have a higher record density and, particularly, the magnetic head slider is required to fly at a low height such that the magnetic disk and the record/reproduction element are maximally close to each other to increase a bit density (record density in the circumferential direction). Accordingly, a gap (flying height) between the magnetic head slider and the magnetic disk around the record/reproduction element is about 10 nm.

As a magnetic disk that is used in the magnetic disk device, a metallic thin film magnetic recording medium is used. In the metallic thin film magnetic recording medium, after a base film made of Cr, etc. is formed by depositing or sputtering on an Al alloy substrate subjected to Ni—P plating or a nonmagnetic substrate such as a glass substrate having a nonmagnetic intermediate film, a Co base alloy magnetic film having uniaxial magnetic anisotropy, such as CoCrPt, CoNiCr, and CoCrTa, is formed on the base film, and a magnetic film and a protective film having high slide resistance and corrosion resistance are further formed.

It is preferable, as a feature of the magnetic disk, that a defective portion hindering recording/reproducing operation do not exist. However, in actuality, during the manufacturing process of the magnetic disk, defects may be generated due to various factors. For this reason, there is a need to inspect whether defects and the size of the defects in the manufactured magnetic disk exceed the allowable number and size.

In the defect inspection of the magnetic disk, defective portions are checked by floating a test magnetic head slider on the magnetic disk, writing a high frequency signal to a predetermined track on the magnetic disk by the recording element, and measuring an average read voltage around the track by a reproducing element. When there are a defective portion hindering recording/reproducing operation in the predetermined track on the magnetic disk, the defective portion can be recognized as an error, such as a modulation error or a thermal asperity error.

When data is read from/written to a magnetic disk, the magnetic disk rotates at a high speed, and circumferential speeds on the inner and outer circumferential sides on the magnetic disk are significantly different from each other. Consequently, on the inner and outer circumferential sides, the speeds of air flows into the magnetic head slider are significantly different from each other. As a result, the flying height may substantially vary on the inner and outer circumferential sides.

As described above, if the flying height substantially varies on the inner and outer circumferential sides, a defective portion cannot be detected with the same precision on the inner and outer circumferential sides in the inspection of the magnetic disk. Further, if the flying height varies on the inner and outer circumferential sides of the magnetic disk when the magnetic disk is actually used, a read/write characteristic varies, which affects the reliability of the magnetic disk device.

Accordingly, Japanese Patent Application Publication (KOKAI) No. 2004-295984 discloses a conventional technology for suppressing the floating variation of when the circumferential speed varies by providing a groove deeper than a negative pressure region in the floating surface of the head slider.

However, as in the conventional technology, if a groove deeper than a negative pressure region is provided, the floating surface needs to be configured to have at least four steps of different heights, resulting in complicated structure. This increases manufacturing costs and production tolerances.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of a head slider according to a first embodiment of the invention;

FIG. 2 is an exemplary plan view of the floating surface of the head slider in the first embodiment;

FIG. 3 is an exemplary cross-sectional view taken along the line α-α′ of FIG. 2 in the first embodiment;

FIG. 4 is an exemplary plan view of the floating surface of a head slider according to a conventional technology;

FIG. 5 is an exemplary diagram of an analysis result of the difference in the flying height variation of the head slider with respect to the circumferential speed variation depending on the presence of a center rail connection wall in the first embodiment;

FIG. 6 is an exemplary schematic diagram for explaining the position of the center rail connection wall in the slider longitudinal direction in the first embodiment;

FIG. 7 is an exemplary schematic diagram for explaining variation in the flying height of the head slider due to variation of the circumferential speed with respect to the position of the center rail connection wall in the first embodiment;

FIG. 8 is an exemplary view of a magnetic disk device with a linear actuator in the first embodiment;

FIG. 9 is an exemplary view of a magnetic disk device with a rotary actuator in the first embodiment;

FIG. 10 is an exemplary schematic diagram for explaining variation in the angle of the head slider and air inflow direction in the first embodiment;

FIG. 11 is an exemplary schematic diagram for explaining the correction of a head slider angle with a second actuator in the first embodiment;

FIG. 12 is an exemplary plan view of the floating surface of a head slider according to a second embodiment of the invention;

FIG. 13 is an exemplary plan view of the floating surface of a head slider according to a third embodiment of the invention;

FIG. 14 is an exemplary plan view of the floating surface of a head slider according to a fourth embodiment of the invention;

FIG. 15 is an exemplary plan view of the floating surface of a head slider according to a fifth embodiment of the invention;

FIG. 16 is an exemplary cross-sectional view taken along the line β-β′ of in FIG. 15 in the fifth embodiment; and

FIG. 17 is an exemplary plan view of the floating surface of a head slider according to a sixth embodiment of the invention.

### DETAILED DESCRIPTION

Various embodiments according to the invention will be described hereinafter with reference to the accompanying drawings. In general, according to one embodiment of the invention, a head slider comprises a center pad, a pair of center rails, and a center rail connection wall. The center pad is configured to be located in the center on the air outflow end side. The center rails are configured to extend toward the air inflow end side continuously from the center pad. The center rail connection wall is configured to connect the ends of the center rails on the air inflow end side to surround a space between the center pad and the center rails, and have a height between the top surface and the bottom surface of a floating surface.

According to another embodiment of the invention, a storage device comprises a head slider configured to write data to or read data from a storage medium. The head slider comprises a center pad, a pair of center rails, and a center rail connection wall. The center pad is configured to be located in the center on the air outflow end side. The center rails are configured to extend toward the air inflow end side continuously from the center pad. The center rail connection wall is configured to connect the ends of the center rails on the air inflow end side to surround a space between the center pad and the center rails, and have a height between the top surface and the bottom surface of a floating surface.

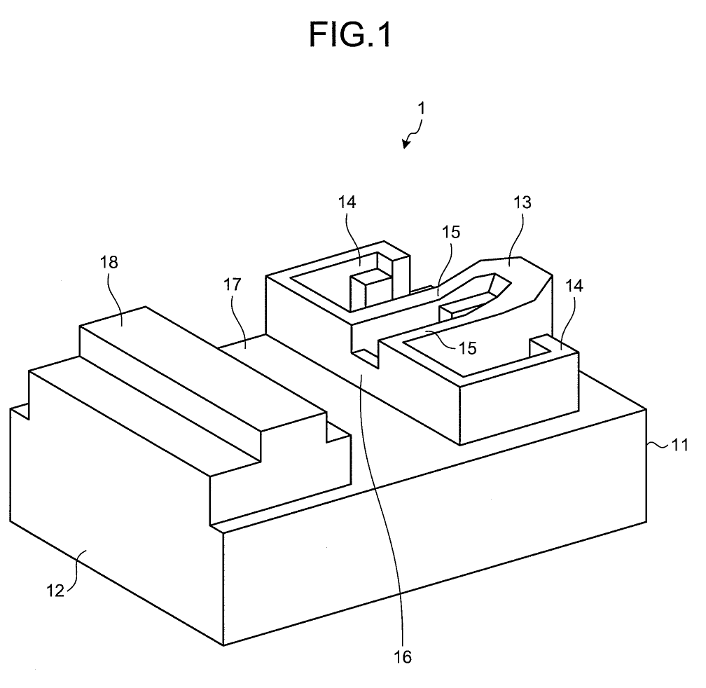

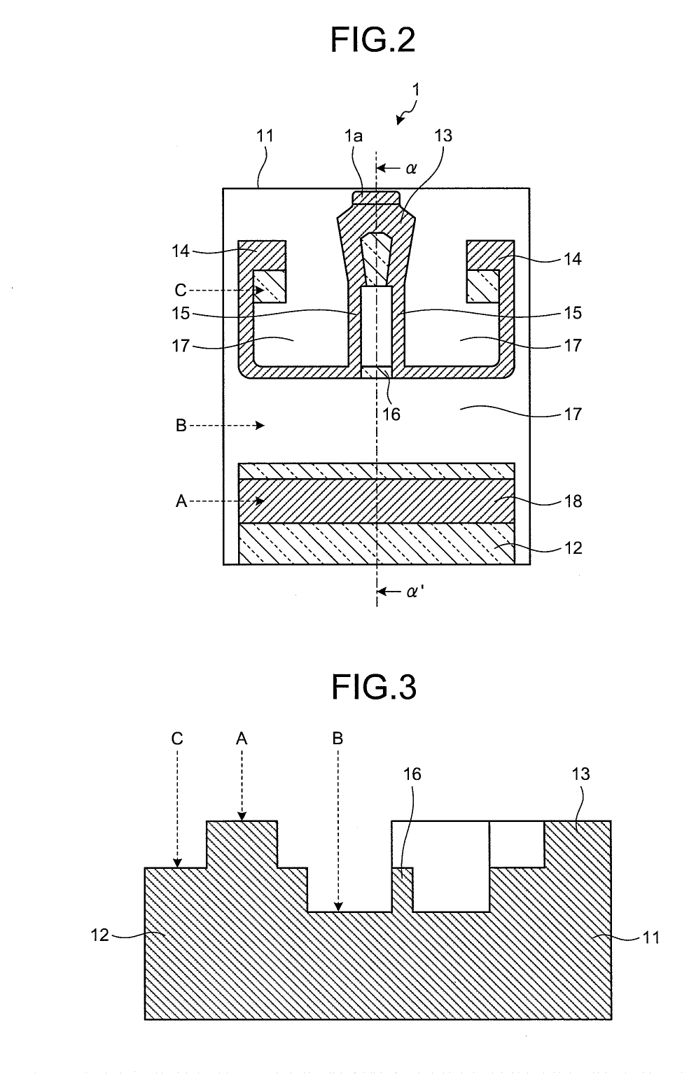

FIG. 1 is a perspective view of a head slider 1 according to a first embodiment of the invention. FIG. 2 is a plan view of the floating surface of the head slider 1. FIG. 3 is a cross-sectional view taken along the line α-α′ of FIG. 2.

As illustrated in FIGS. 1 to 3, the head slider 1 comprises an air outflow end 11, an air inflow end 12, and a center pad 13, side pads 14, a pair of center rails 15, a center rail connection wall 16, a negative pressure region 17, and an inflow-side protrusion 18 on the floating surface thereof.

The center pad 13 is located in the center on the air outflow end 11 side in the width direction, and comprises a record/reproduction element la that records and reproduces information with respect to a disk. Further, the center pad 13 is configured using an top surface A of the floating surface and a surface C that has the height between the top surface A and a bottom surface B.

The side pad 14 are bosses that are provided on the left and right of the center pad 13 or the center rails 15, respectively, and are formed of the top surface A of the floating surface and the surface C having the height between the top surface A and the bottom surface B.

From the center pad 13, the center rails 15 configured to have the height of the top surface A of the floating surface extend toward the side of the air inflow end 12.

In such a manner as to close a space between the center rails 15, the center rail connection wall 16 as a ridge of a uniform height that is formed of the surface C having a height between the top surface A and the bottom surface B of the floating surface is provided in the end portion of the space in front of the center pad 13.

In regards to the shape of the floating surface of the head slider 1, the center rails 15 are bent at an approximately right angle at a position of the center rail connection wall 16 and extend to the sides of both ends in the width direction, and are curved at an approximately right angle in the vicinity of the side end of the head slider 1 and connected to the side pads 14, to surround the negative pressure region 17 on the side of the air outflow end 11.

The negative pressure region 17 is a region of the bottom surface B in the head slider 1. The region of the bottom surface B receives an airflow that is generated when the head slider 1 moves on the magnetic disk at a high speed, and generates a pressure of a direction where the head slider 1 is away from the magnetic disk, i.e., a direction where the flying height increases.

The inflow-side protrusion 18 is a boss that is provided on the side of the air inflow end 12 of the head slider 1, and is formed of the top surface A and the intermediate surface C.

That is, as illustrated in FIG. 3, the head slider 1 is configured of the three surfaces of the top surface A, the bottom surface B, and the intermediate surface C. If the depths of the bottom surface B and the surface C at a different height between the top surface and the bottom surface are exemplified based on the top surface A of the floating surface of the head slider 1 as a reference, the depth of the bottom surface B is 2.0 to 4.0 μm from the top surface A, and the depth of the surface C is 0.1 to 2.0 μm from the top surface A.

The floating surface of the head slider 1 is processed by milling or etching. Accordingly, a series of processes, such as resist coating, resist processing using a photolithographic technology, processing of an object material using the milling or etching, and resist removing, are performed, whenever a surface having an arbitrary height is formed. As a result, the manufacturing cost increases and processing precision is lowered. For this reason, the number of surfaces that are formed on the floating surface of the head slider 1 is preferably as small as possible.

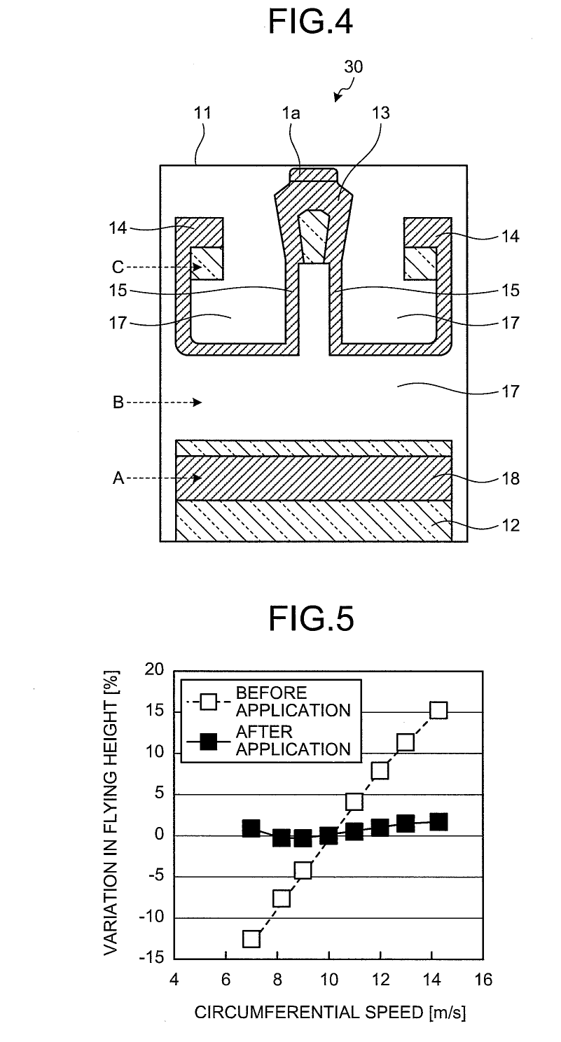

Referring to FIG. 4, the shape of the floating surface of the head slider 1 of the first embodiment and the shape of the floating surface of a head slider according to a conventional technology are compared. FIG. 4 is a plan view of the floating surface of a head slider 30 of the conventional technology. As illustrated in FIG. 4, the head slider 30 is different from the head slider 1 in that there is no center rail connection wall 16. Otherwise, the head slider 30 is basically similar to the head slider 1.

As described above, the center rail connection wall 16 is formed having the height of the intermediate surface C, and the intermediate surface C is used also in the conventional structure. For this reason, even if the center rail connection wall 16 is provided as in the head slider 1, the cost required for the work does not increase and the precision does not decrease as compared with the conventional structure.

FIG. 5 illustrates an analysis result of the difference in the flying height variation of the head slider with respect to the circumferential speed variation depending on the presence of the center rail connection wall 16. In FIG. 5, with respect to the magnetic disk using the head slider 30 where the center rail connection wall 16 is not applied and the magnetic disk using the head slider 1 of the first embodiment where the center rail connection wall 16 is applied, the horizontal axis represents the circumferential speed of the rotation of the magnetic disk, while the vertical axis represents the relative amount of the flying height variation with respect to the circumferential speed variation based on the flying height at the position of the record/reproduction element of when the circumferential speed is 10 m/s.

As illustrated in FIG. 5, in the head slider 30 without the center rail connection wall 16, when the circumferential speed is varied in a range of 7 to 14 ms, the flying height is greatly varied in a range of −13 to +15%. According to the analysis result, in the head slider 1 that has the floating surface where the center rail connection wall 16 is applied, the flying height varies by only a maximum of approximately 2%, and the variation in the flying height with respect to the circumferential speed can be reduced to approximately 60%, with respect to the floating surface according to the conventional technology.

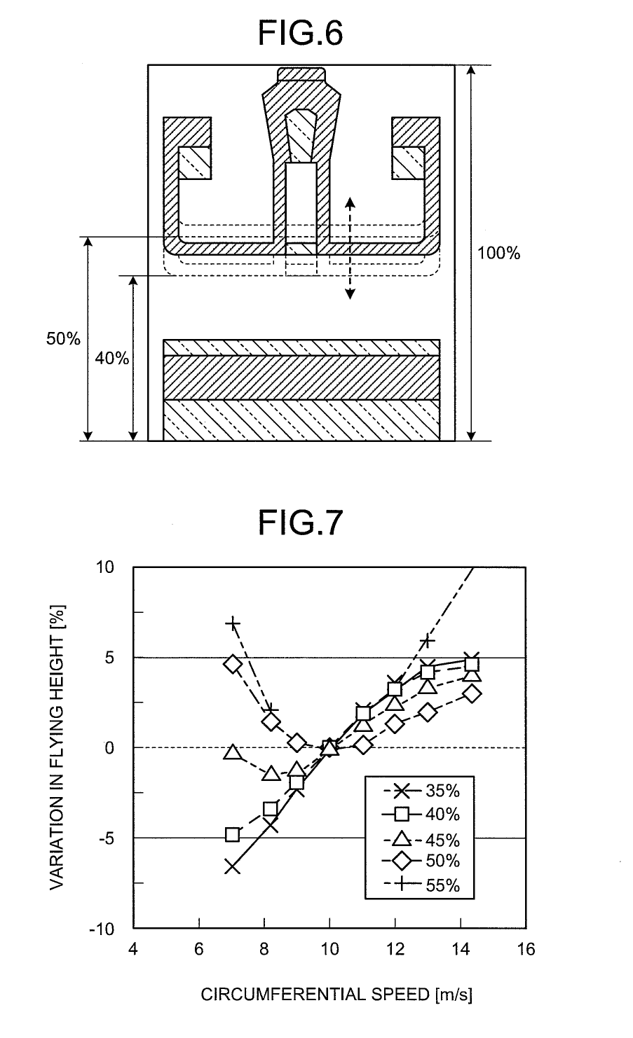

Next, a description will be given of the position where the center rail connection wall 16 is arranged. FIG. 6 illustrates the position of the center rail connection wall 16 in the slider longitudinal direction in regards to the magnetic disk device that comprises the head slider 1. FIG. 7 illustrates the flying height variation of the head slider due to the circumferential speed variation with respect to the position of the center rail connection wall 16. As described above, since the center rail connection wall 16 is provided to connect the ends of the center rails 15 in a slider longitudinal direction, the position where the center rails 15 extend to the sides of both ends of the head slider in the width direction varies according to the position of the center rail connection wall 16.

Referring to FIG. 7, if the center rail connection wall 16 is located at a position separated from the air inflow end 12 by 40 to 50% of the length of the head slider, the flying height variation with respect to the circumferential speed variation can be maintained at approximately ±5% in a range of the circumferential speeds of 7 to 14 ms/s.

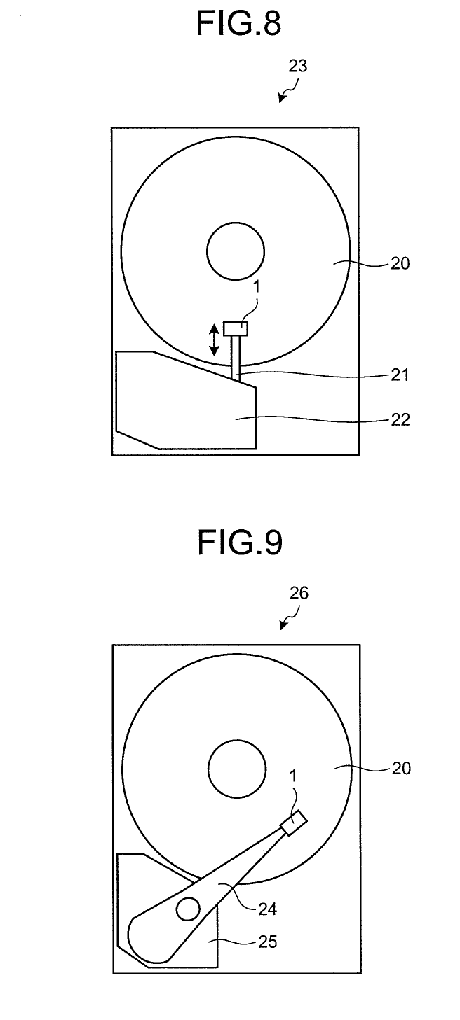

Next, the magnetic disk device using the head slider 1 will be described with reference to FIGS. 8 and 9.

FIG. 8 illustrates a magnetic disk device 23 with a linear actuator 22. The magnetic disk device 23 illustrated in FIG. 8 is configured such that an arm 21 is connected to the linear actuator 22 and the head slider 1 is provided in the front end of the arm 21. Accordingly, if the linear actuator 22 expands and contracts the arm 21, the position of the head slider 1 with respect to a radial direction of a magnetic disk 20 is varied, and data can be read and written in a different track of the magnetic disk 20. When the position of the head slider 1 is varied by the linear actuator 22, an angle of the head slider 1 and the air inflow direction is constantly maintained, even though the position of the head slider 1 is varied.

The magnetic disk device 23 where the arm 21 is linearly moved by the linear actuator 22 as described above is widely used as a magnetic disk device that inspects defects of the magnetic disk 20 as well as a common magnetic disk device that reads and writes user data.

FIG. 9 illustrates a magnetic disk device 26 with a rotary actuator 25. The magnetic disk device 26 illustrated in FIG. 9 is configured such that an arm 24 is connected to the rotary actuator 25 and the head slider 1 is provided in a front end of the arm 24. Accordingly, if the rotary actuator 25 rotates the arm 24, a position of the head slider 1 with respect to a radial direction of the magnetic disk 20 is varied, and data can be read and written in a different track of the magnetic disk 20.

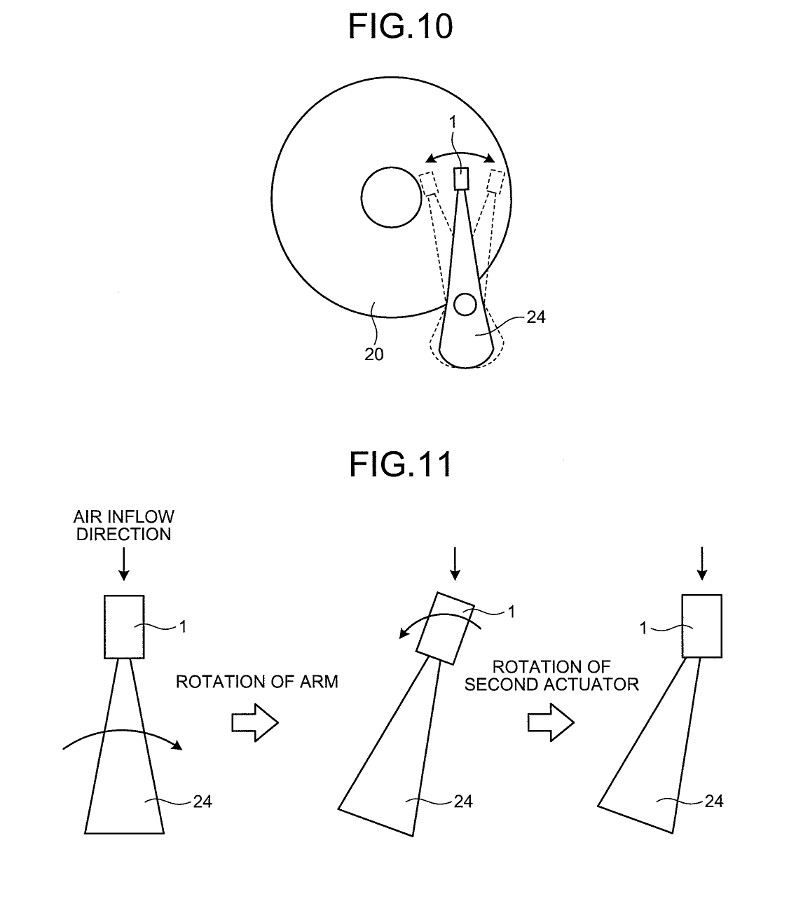

When the position of the head slider 1 is varied with the rotary actuator 25, the angle of the head slider 1 and air inflow direction varies as illustrated in FIG. 10.

Accordingly, in recent years, a second actuator (not illustrated) is interposed between the arm 24 and the head slider 1, as illustrated in FIG. 11, the variation in the angle of the head slider 1 and the air inflow direction that is generated by the rotation of the arm 24 is absorbed by the rotation of the second actuator, and the angle of the head slider 1 and the air inflow direction is constantly maintained.

As described above, according to the first embodiment, the center rail connection wall 16 is provided to connect the ends of the center rails 15 on the air inflow end side in such a manner as to surround the space between the center pad 13 and the center rails 15. That is, in the shape of the floating surface, the amount of air flowing in the center pad is adjusted by the center rails and the center rail connection wall located in front of the center pad. As a result, the floating surface where the flying height variation with respect to the circumferential speed variation is small can be formed without an increase in the number of steps of the floating surface. Thus, the floating surface can be formed without an increase in the manufacturing costs of a head slider for a magnetic disk test device and the production tolerance.

If the shape illustrated in the first embodiment is applied to the shape of the floating surface of a head slider for a magnetic disk device, particularly, a magnetic disk test device, the floating surface where the flying height variation with respect to the circumferential speed variation of the magnetic disk is small can be designed, and the reliability of the magnetic disk device can be improved. The shape of the floating surface described above can be effectively applied to a device where the variation in the angle (yaw angle) of the magnetic disk rotation direction and the head slider is small, and may be applied to, for example, a magnetic disk device provided with a linear actuator or a second actuator.

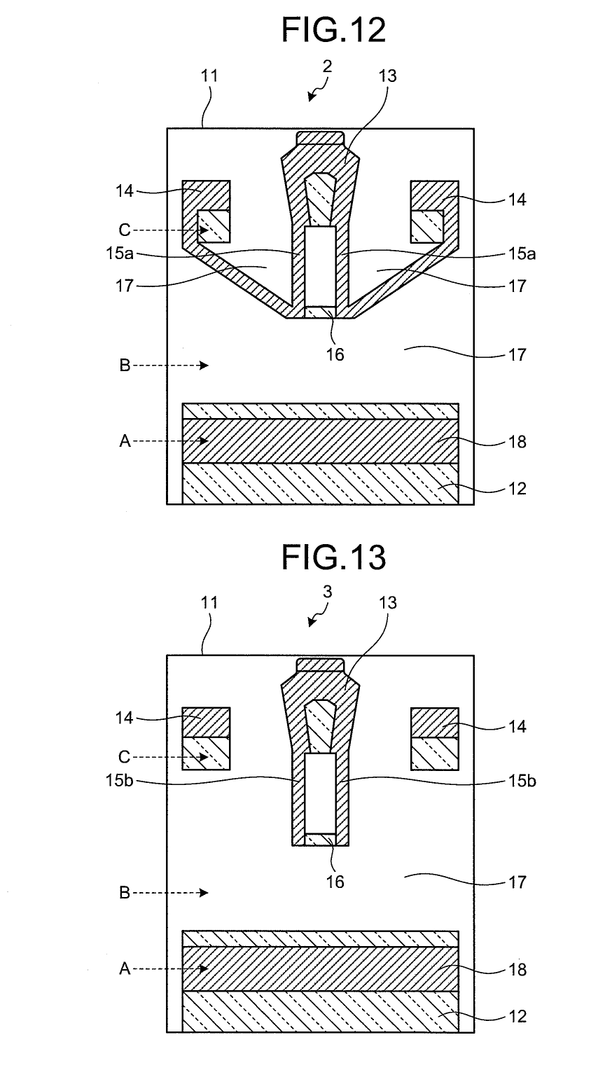

FIG. 12 is a plan view of the floating surface of a head slider 2 according to a second embodiment of the invention. As illustrated in FIG. 12, the head slider 2 is different from the head slider 1 of the first embodiment in the shape of the center rails 15. Specifically, center rails 15a of the head slider 2 are bent at an acute angle at a position of the center rail connection wall 16 and extend, are connected to the side pads 14, and surround the negative pressure region 17 on the side of the air outflow end 11.

Otherwise, the head slider 2 is of basically the same configuration as the head slider 1 of the first embodiment. Accordingly, even if the center rails 15a are bent at an acute angle and connected to the side pads 14 and their shapes vary, the variation in the flying height due to the variation in the circumferential speed can be suppressed as with the head slider 1 of the first embodiment.

FIG. 13 is a plan view of the floating surface of a head slider 3 according to a third embodiment of the invention. As illustrated in FIG. 13, the head slider 3 is different from the head slider 1 of the first embodiment in the shape of the center rails 15. Specifically, center rails 15b of the head slider 3 have terminating ends at the position of the center rail connection wall 16, and are independent from the side pads 14.

Otherwise, the head slider 3 is of basically the same configuration as the head slider 1 of the first embodiment. Accordingly, even if the center rails 15b are configured to be independent from the side pads 14, the flying height variation due to the circumferential speed variation can be suppressed as with the head slider 1 of the first embodiment.

### Fourth Embodiment

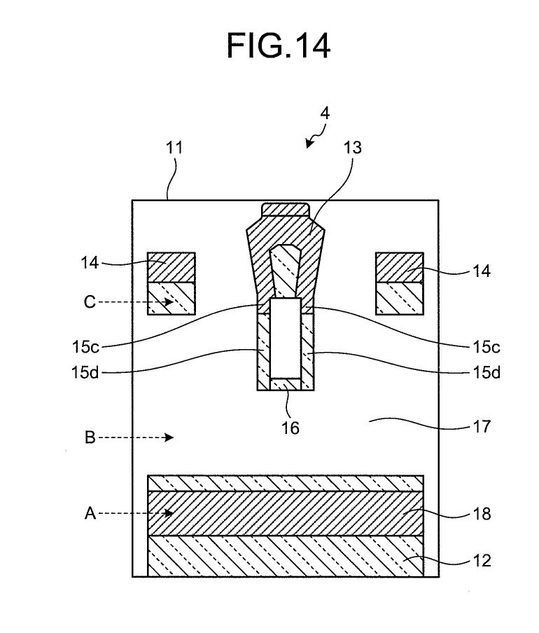

FIG. 14 is a plan view of the floating surface of a head slider 4 according to a fourth embodiment of the invention. As illustrated in FIG. 14, the head slider 4 is different from the head slider 3 of the third embodiment in the shape of the center rails 15. Specifically, center rails of the head slider 4 are divided into center rails 15c having the height of an top surface A and center rails 15d having the height of an intermediate surface C.

Otherwise, the head slider 4 is of basically the same configuration as the head slider 3 of the third embodiment. That is, in the head slider 4, a portion of the center rails has the same height as the center rail connection wall 16. Accordingly, even if steps are formed in the center rails, the flying height variation due to the circumferential speed variation can be suppressed as with the head slider 1 of the first embodiment.

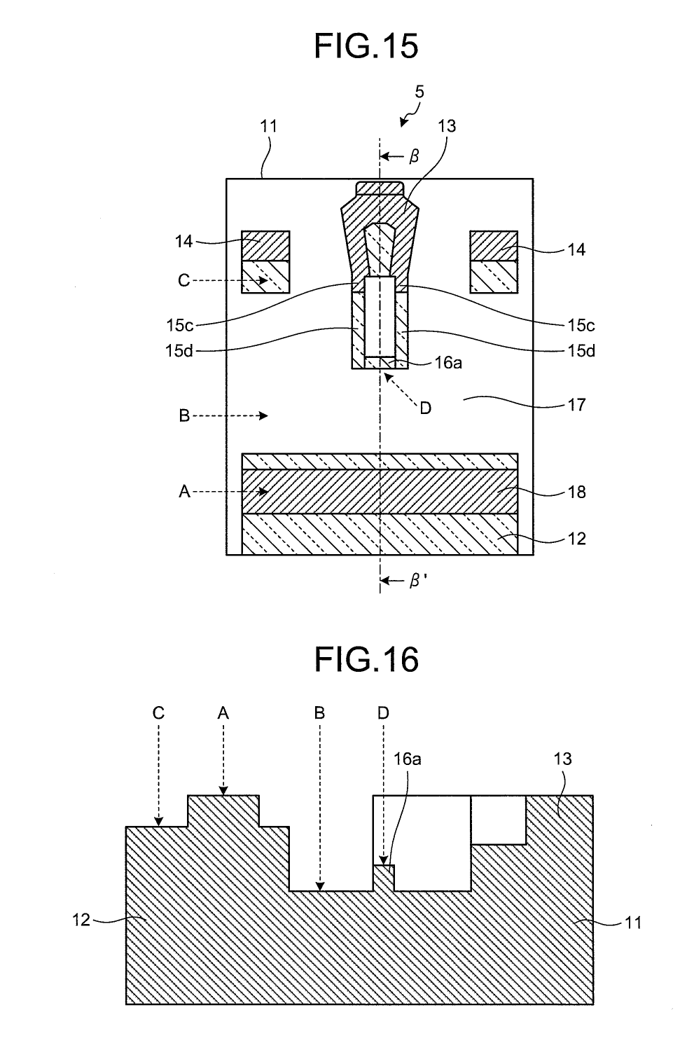

FIG. 15 is a plan view of the floating surface of a head slider 5 according to a fifth embodiment of the invention. FIG. 16 is a cross-sectional view taken along the line β-β′ of FIG. 15. As illustrated in FIGS. 15 and 16, the head slider 5 is different from the head slider 4 of the fourth embodiment in the height of a center rail connection wall 16a. Specifically, the center rail connection wall 16a of the head slider 5 is formed of a surface D positioned lower than the intermediate surface C and positioned higher than the bottom surface B.

Otherwise, the head slider 5 is of basically the same configuration as the head slider 4 of the fourth embodiment. That is, in the head slider 5, steps are formed in the center rails, and the center rail connection wall 16a is positioned to be lower than the center rails. Even with this configuration, the flying height variation due to the circumferential speed variation can be suppressed as with the head slider 1 of the first embodiment. Meanwhile, since the number of manufactured surfaces increases as compared to the first to fourth embodiments, preferably, the configuration of the head slider 5 is applied to the case where setting the height of the center rail connection wall 16a to be lower than that of the center rails 15d is still effective if taking into account an increase in manufacturing cost and a decrease in processing precision.

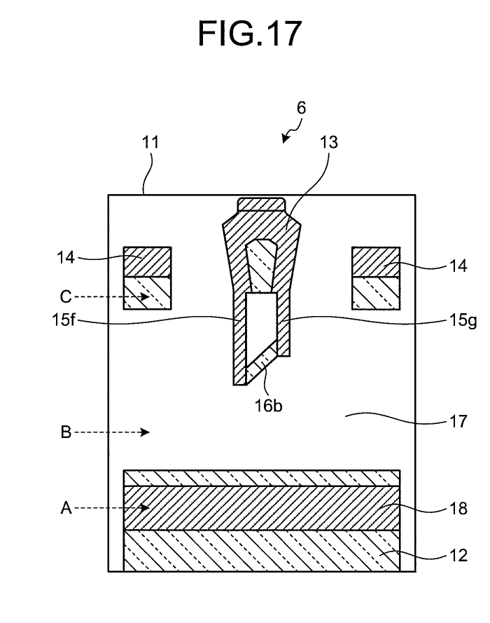

FIG. 17 is a plan view of the floating surface of a head slider 6 according to a sixth embodiment of the invention. As illustrated in FIG. 17, the head slider 6 is different from the head slider 3 of the third embodiment in the shape of the center rails. Specifically, a pair of center rails 15f and 15g of the head slider 6 have different lengths. That is, in the head slider 6, the center rails are asymmetrical in a slider width direction. As a result, a center rail connection wall 16b has an inclination with respect to the longitudinal direction of the head slider 6.

Otherwise, the head slider 6 is of basically the same configuration as that of the head slider 3 of the third embodiment. Accordingly, even with the configuration where the center rails are asymmetrical and the center rail connection wall 16b has the inclination, the flying height variation due to the circumferential speed variation can be suppressed as with the head slider 1 of the first embodiment.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A head slider comprising:
a center pad in a center on an air outlet side;
a pair of center rails extending toward an air inlet side continuously from the center pad; and
a center rail connection wall configured to connect ends of the center rails on the air inlet side surrounding a space between the center pad and the center rails, and comprises a height between an top surface and a bottom surface of a floating surface.

2. The head slider of claim 1, wherein the center rails comprise stepped portions of at least two steps comprising the top surface of the floating surface and a surface at a different height between the top surface and the bottom surface.

3. The head slider of claim 2, wherein a height of a top surface of the center rail connection wall is different from a height of the surface of the center rails.

4. The head slider of claim 1, wherein the center rails are asymmetrical in a slider width direction.

5. The head slider of claim 1, further comprising a pair of side pads on left and right of the center pad or the center rails wherein
the ends of the center rails on the air inlet side are connected to the side pads and extending toward outside in a slider width direction in order to surround a negative pressure region.

6. The head slider of claim 1, wherein the center rail connection wall is away from an air inlet by 40 to 50% of a length of the head slider in a slider longitudinal direction.

7. A storage device comprising ahead slider configured to write data to or read data from a storage medium, the head slider comprising:
a center pad in a center on an air outlet side;
a pair of center rails extending toward an air inlet side continuously from the center pad; and
a center rail connection wall configured to connect ends of the center rails on the air inlet side surrounding a space between the center pad and the center rails, and comprises a height between an top surface and a bottom surface of a floating surface.

8. The storage device of claim 7, wherein the center rails comprise stepped portions of at least two steps comprising the top surface of the floating surface and a surface at a different height between the top surface and the bottom surface.

9. The storage device of claim 8, wherein a height of a top surface of the center rail connection wall is different from a height of the surface of the center rails.

10. The storage device of claim 7, wherein the center rails are asymmetrical in a slider width direction.

11. The storage device of claim 7, further comprising a pair of side pads on left and right of the center pad or the center rails wherein
the ends of the center rails on the air inlet side are connected to the side pads and extending toward outside in a slider width direction in order to surround a negative pressure region.

12. The storage device of claim 7, wherein the center rail connection wall is configured to be located, in a slider longitudinal direction, at a position separated from an air inflow end by 40 to 50% of length of the head slider.
